(19) United States
(12) Patent Application Publication
(10) Pub. No.: US 2026/0246010 A1
(43) Pub. Date: Aug. 20, 2026

(54) BATTERY CELL

(71) Applicant: Toyota Jidosha Kabushiki Kaisha, Toyota-shi (JP)

(72) Inventor: Tsuyoshi EHARA, Toyota-shi (JP)

(73) Assignee: Toyota Jidosha Kabushiki Kaisha, Toyota-shi (JP)

(21) Appl. No.: 19/421,279

(22) Filed: Dec. 16, 2025

(30) Foreign Application Priority Data
Feb. 14, 2025 (JP) 2025-022414

(51) Int. Cl. H01M 10/653; H01M 10/647; H01M 50/103; H01M 50/119

(52) U.S. Cl. CPC H01M 10/653; H01M 10/647; H01M 50/103; H01M 50/119

(57) ABSTRACT

A battery cell includes: an electrode body; a metal case configured to house the electrode body; and a resin heat-conductive sheet disposed between the electrode body and the case inside the case and in contact with both the electrode body and the case. Young's modulus of the resin heat-conductive sheet is less than Young's modulus of the electrode body.

### BACKGROUND

The present disclosure relates to a battery cell.

JP2020113496A discloses an all-solid-state battery cell in which an electrode laminate is encapsulated within a case, including a heat transfer material provided inside the case and contacting both the bottom surface of the case and the electrode body.

### SUMMARY

In the configuration described in JP2020113496A, when the electrode body thermally expands, a load acting from the electrode body to the heat transfer material compresses the heat transfer material toward the case. If the reaction force from the heat transfer material is large, damage can occur to the electrode body.

There is a need for a battery cell capable of suppressing damage to the electrode body when it undergoes thermal expansion.

According to one aspect of the present disclosure, there is provided a battery cell including: an electrode body; a metal case configured to house the electrode body; and a resin heat-conductive sheet disposed between the electrode body and the case inside the case and in contact with both the electrode body and the case, wherein Young's modulus of the resin heat-conductive sheet is less than Young's modulus of the electrode body.

### BRIEF DESCRIPTION OF THE DRAWINGS

FIG. 1 is a perspective view showing a battery cell according to an embodiment;

FIG. 2 is a diagram illustrating an internal structure of the battery cell;

FIG. 3 is a cross-sectional view showing the internal structure of the battery cell; and

FIG. 4 is a cross-sectional view showing the laminated structure of the case, heat-conductive sheet, and electrode body.

### DETAILED DESCRIPTION

The battery cell in the embodiment of the present disclosure will now be described in detail. Note that the present disclosure is not limited to the embodiment described below.

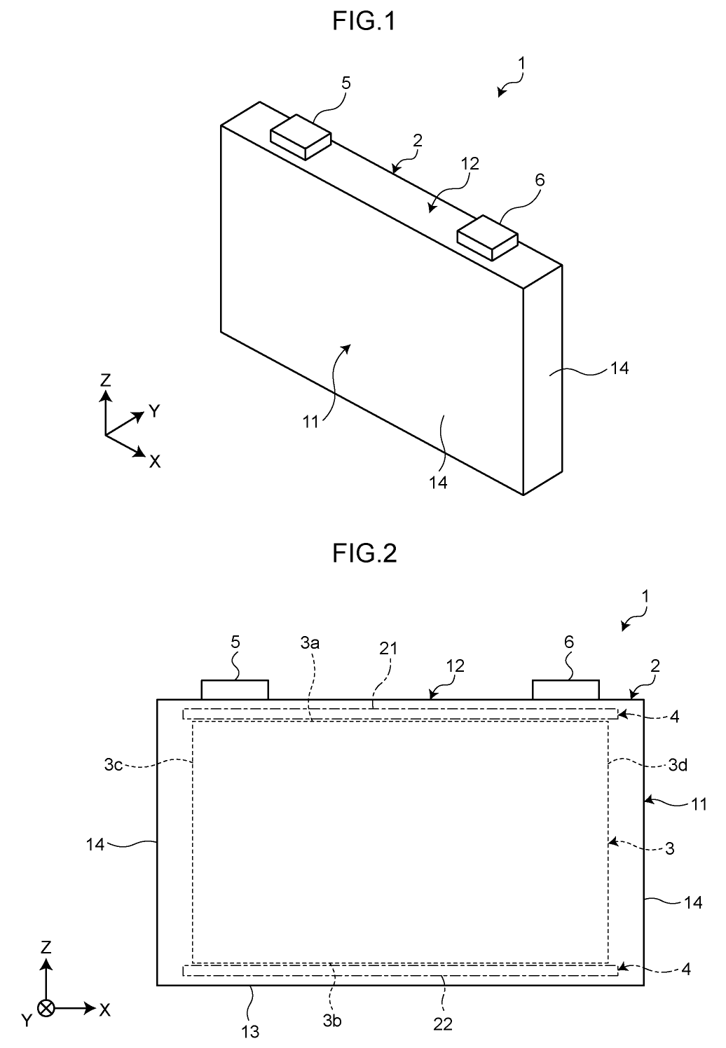

FIG. 1 is a perspective view showing a battery cell in the embodiment. The battery cell 1 is a prismatic cell. The battery cell 1 includes a case 2, an electrode body 3, a heat conduction sheet 4, and terminals 5 and 6. As illustrated in FIG. 2, the interior of the case 2 houses the electrode body 3, the heat conduction sheet 4, and the electrolyte.

The case 2 is a metal case that houses the electrode body 3. The case 2 forms a metal layer. The case 2 is a rectangular can formed into a roughly rectangular prism shape. For example, the case 2 is composed of aluminum or an aluminum alloy. The case 2 has a case body 11 and a lid 12. The case body 11 is a housing having an opening at the top. Lid 12 is joined to the case body 11 so as to close the opening of case body 11. The case body 11 and the lid body 12 are joined by welding. The interior of the case 2 is sealed. The interior of the case 2 houses an electrode body 3, a heat-conducting sheet 4, and an electrolyte.

The electrode body 3 is a wound body whose upper edge 3a and lower edge 3b in the height direction of the battery cell 1 are sealed. The electrode body 3 forms the electrode layer. In the electrode body 3, one end portion 3c in the width direction of the battery cell 1 is a positive electrode connection portion where only the portion exposing the positive electrode current collector is wound, and the other end portion 3d is a negative electrode connection portion where only the portion exposing the negative electrode current collector is wound. The terminal 5, the external terminal on the positive electrode side, is electrically connected to the positive electrode connection portion. The terminal 6, the external terminal on the negative electrode side, is electrically connected to the negative electrode connection section. Both end sections 3c and 3d are open in the width direction of the battery cell 1. When viewed from the thickness direction of the battery cell 1, the two sides including the upper edge 3a and the lower edge 3b form a closed section, while the two sides including the end sections 3c and 3d form an open section. Battery cell 1 has closed sections in the electrode layers of at least two of its four sides. Conversely, in the open sections, electrolyte can move between the interior and exterior of electrode body 3 via end portions 3c and 3d. Electrolyte exists both inside electrode body 3 and as excess liquid outside it. The majority of the electrolyte permeates into the interior of electrode body 3. Surplus electrolyte not permeated into the interior of the electrode body 3 accumulates on the bottom 13 side of the case 2. As the battery cell 1 undergoes repeated charging and discharging, expansion and contraction of the electrode body 3 occur due to the charging and discharging.

For example, the electrode body 3 includes a strip-shaped positive electrode sheet, a strip-shaped negative electrode sheet, and a strip-shaped separator. The electrode body 3 has a laminated structure where the positive electrode sheet, negative electrode sheet, and separator are stacked. The electrode body 3 is a rolled structure. The electrode body 3 is a flat electrode body formed by rolling a laminated structure where the positive electrode sheet and negative electrode sheet are stacked via the separator. The pre-wound laminate is stacked in the thickness direction in the order: positive electrode sheet, separator, negative electrode sheet, separator. In electrode body 3, the positive electrode sheet, negative electrode sheet, and separator are stacked such that their respective longitudinal directions align. The positive electrode sheet includes a positive electrode current collector and a positive electrode active material layer. The positive electrode current collector is a long positive electrode substrate. The positive electrode active material layer is provided on the positive electrode current collector. The positive electrode current collector includes a positive electrode side uncoated portion at one end in the width direction where the positive electrode active material layer is not formed, exposing the positive electrode current collector. This positive electrode side uncoated portion forms the positive electrode current collector portion when the positive electrode sheet is wound. A positive electrode collecting terminal is connected to the positive electrode collecting section. The positive electrode collecting terminal is connected to terminal 5, which is the external terminal on the positive electrode side. The negative electrode sheet includes a negative electrode collector and a negative electrode active material layer. The negative electrode collector is a negative electrode base material formed in a long strip. The negative electrode active material layer is provided on the negative electrode collector. The negative electrode current collector includes a negative electrode side uncoated portion where the negative electrode current collector is exposed without the negative electrode active material layer being formed at the other end in the width direction. The negative electrode side uncoated portion forms the negative electrode current collector by winding the negative electrode sheet. A negative electrode current collector terminal is connected to the negative electrode current collector. The negative electrode current collector terminal is connected to terminal 6, which is the external terminal on the negative electrode side.

The heat conduction sheet 4 is positioned between the case 2 and the electrode body 3. The heat conduction sheet 4 is positioned in the closed section of the electrode body 3. In the battery cell 1, a heat transfer layer is positioned between the closed section and the metal layer. The heat conduction sheet 4 is an insulating material, for example, composed of resin. The heat conduction sheet 4 constitutes the heat transfer layer.

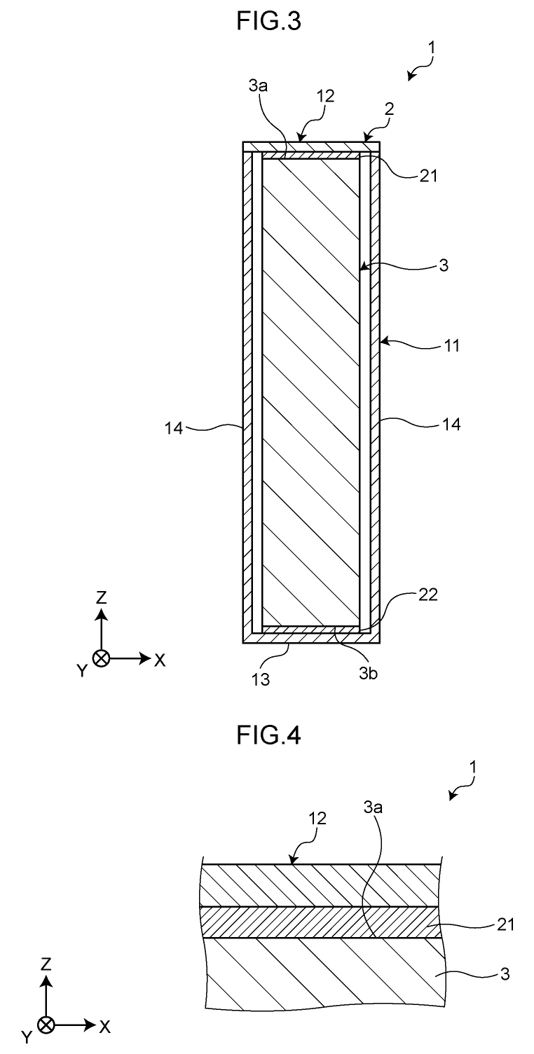

As illustrated in FIG. 3, the heat conduction sheet 4 includes a first heat conduction sheet 21 in contact with the upper edge 3a of the electrode body 3 and a second heat conduction sheet 22 in contact with the lower edge 3b of the electrode body 3.

The first heat conduction sheet 21 is provided between the electrode body 3 and the cover body 12. In the width and thickness directions of the battery cell 1, the first heat conduction sheet 21 is a flat sheet that contacts the entire upper edge 3a of the electrode body 3 and the inner surface of the cover body 12. As illustrated in FIG. 4, a laminated structure is formed where the cover body 12, the first heat conduction sheet 21, and the electrode body 3 are stacked.

The second heat conduction sheet 22 is provided between the electrode body 3 and the bottom 13 of the case body 11. In the width and thickness directions of the battery cell 1, the second heat conduction sheet 22 is a flat sheet that contacts the entire lower edge 3b of the electrode body 3 and the entire inner surface of the bottom 13 of the case body 11. A laminated structure is formed by stacking the bottom 13 of the case body 11, the second heat conduction sheet 22, and the electrode body 3. A cooler is attached to the outer surface of the bottom 13 of the case 2. The cooler cools the electrode body 3 and is provided outside the case 2. In this battery cell 1 with the cooler attached, a cooling structure is provided that cools the electrode body 3 from the bottom 13 side of the case 2 via the second heat conduction sheet 22.

The heat conduction sheet 4 is configured to have a Young's modulus smaller than that of the electrode body 3. The Young's modulus of the heat conduction sheet 4 is smaller than the Young's modulus of the electrode body 3.

If the Young's modulus of the heat-conducting sheet 4 were equivalent to that of the electrode body 3, the reaction force from the heat-conducting sheet 4 during compression would increase, potentially damaging the electrode body 3. To avoid this, the battery cell 1 is configured such that the Young's modulus of the heat-conducting sheet 4 is smaller than that of the electrode body 3. For example, it is preferable that the Young's modulus of the heat conduction sheet 4 is one-hundredth or less of the Young's modulus of the electrode body 3. By reducing the shear force of the heat conduction sheet 4 during deformation when case 2 expands, the reaction force from the heat conduction sheet 4 against the expansion of the electrode body 3 decreases, thereby mitigating damage to the electrode body 3 from the heat conduction sheet 4.

The battery cell 1 has a film structure inside the case 2 for insulation purposes. An insulating film is housed inside the case 2. The insulating film forms an insulating layer. The insulating film is provided between the inner surface of the side wall portion 14 of the case body 11 and the open section of the electrode body 3. On one side of the battery cell 1 in the width direction, an insulating film is positioned between the end portion 3c of the electrode body 3 and the inner surface of the side wall portion 14. On the other side of the battery cell 1 in the width direction, an insulating film is positioned between the end portion 3d of the electrode body 3 and the inner surface of the side wall portion 14. The insulating film provided between the inner surface of the side wall portion 14 of the case body 11 and the side surface of the electrode body 3 may be formed to cover the entire inner surface of the side wall portion 14, or it may be formed to cover the entire side surface of the electrode body 3.

As described above, according to the embodiment, the shear force of the heat conduction sheet 4 decreases when the electrode body 3 expands, thereby suppressing damage to the electrode body 3 from the heat conduction sheet 4.

Furthermore, the thermal conductive sheet 4 can be designed to have a specified size of thermal conductive resin prior to manufacturing the battery cell 1, and to achieve the desired thickness and width after manufacturing.

The present disclosure suppresses damage to the electrode body when it undergoes thermal expansion.

Although the disclosure has been described with respect to the specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A battery cell comprising:
an electrode body;
a metal case configured to house the electrode body; and
a resin heat-conductive sheet disposed between the electrode body and the case inside the case and in contact with both the electrode body and the case,
wherein Young's modulus of the resin heat-conductive sheet is less than Young's modulus of the electrode body.

2. The battery cell according to claim 1, wherein the Young's modulus of the heat-conductive sheet is one-hundredth or less of the Young's modulus of the electrode body.
